(19) United States
(12) Patent Application Publication
(10) Pub. No.: US 2019/0135078 A1
(43) Pub. Date: May 9, 2019

(54) HEATING MEDIUM HEATING DEVICE AND VEHICLE AIR CONDITIONER USING SAME

(71) Applicant: MITSUBISHI HEAVY INDUSTRIES THERMAL SYSTEMS, LTD., Tokyo (JP)

(72) Inventor: Tomoyasu ADACHI, Tokyo (JP)

(73) Assignee: MITSUBISHI HEAVY INDUSTRIES THERMAL SYSTEMS, LTD., Tokyo (JP)

(21) Appl. No.: 16/087,482

(22) PCT Filed: Oct. 21, 2016
(86) PCT No.: PCT/JP2016/081340

§ 371 Date: Sep. 21, 2018

(30) Foreign Application Priority Data
Jun. 10, 2016 (JP) 2016-116317

(51) Int. Cl. B60H 1/22; F24H 3/00; F24H 3/06; F24H 9/18; F24H 9/20; H05B 1/02; H05B 3/22

(52) U.S. Cl. CPC B60H 1/2221; F24H 3/002; F24H 3/06; F24H 9/1872; H05B 2203/02; H05B 1/0236; H05B 3/22; F24H 2250/04; F24H 9/2071

(57) ABSTRACT

A heating medium heating device (10) includes: a PTC heater (40); a first heating medium distribution box (20) tightly sealed to one surface side of the PTC heater (40) and having a first heating medium distribution path (41) formed therein; a second heating medium distribution box (50) that is tightly sealed to the other surface side of the PTC heater (40) and having a second heating medium distribution path (42) formed therein, and which is connected to the first heating medium distribution box (20); an inlet header space (44) and outlet header space (45) that respectively connect the upstream ends and downstream ends of the first and second heating medium distribution paths (41, 42); an inlet portion (47) that feeds the heating medium into the inlet header space (44); and an outlet portion (48) that discharges the heating medium from the outlet header space (45).

### TECHNICAL FIELD

The invention relates to a heating medium heating device configured to heat heating medium by means of a positive temperature coefficient (PTC) heater and to a vehicle air conditioner using the heating medium heating device.

### BACKGROUND ART

Hybrid vehicles have difficulty using the engine exhaust to heat the inside of the passenger compartment and electric-motor vehicles are equipped with no engines. A vehicle of such kinds is provided with a dedicated heating medium heating device configured to heat heating medium (engine cooling fluid, brine, or the like liquid) that is supplied to a heater core for warming air disposed in the passenger compartment. Use of a PTC heater as part of such a heating medium heating device is known, and some examples of such use are disclosed in Patent Documents 1 to 3. A PTC heater employs a positive temperature coefficient thermistor element (a.k.a. PTC element) as a heat generating element, and a PTC element may be formed in a thin, plate shape, which allows the heating medium heating device to be formed in a thin and compact device.

Each of the heating medium heating devices disclosed in Patent Documents 1 to 3 includes: a first heating medium distribution box including a heating medium circulation path formed inside of the first heating medium distribution box; a second heating medium distribution box including a heating medium circulation path formed inside of the second heating medium distribution box; and a PTC heater. The first and the second heating medium distribution boxes are adhered closely together with the PTC heater disposed between these boxes. The heating medium firstly flows through a first end to a second end of the heating medium circulation path of the first heating medium distribution box. Then, the heating medium makes a U-turn and flows through a first end to a second end of the heating medium circulation path of the second heating medium distribution box. Then, the heating medium makes another U-turn and flows from the second end to the first end. In the meanwhile, the heating medium exchanges heat with the two surfaces of the PTC heater, and is thus heated.

In addition, a case-like board accommodating space is formed in any one of the first heating medium distribution box and the second heating medium distribution box. The board accommodating space is configured to accommodate a board for controlling the PTC heater and to accommodate heat-generating electronic components (IGBT, FET, and the like). Heat is exchanged between the electronic components accommodated in the board accommodating space and the heating medium, and thus the heat dissipated from the electronic components is cooled.

In addition, an inlet portion configured to allow the heating medium to flow into the heating medium circulation path of the first heating medium distribution box and an outlet portion configured to allow the heating medium to flow out of the heating medium circulation path of the second heating medium distribution box are formed in a side surface of either the first heating medium distribution box or the second heating medium distribution box. Each of the inlet portion and the outlet portion has a shape that allows for the connection of a hose member that forms a part of a heating medium circulation circuit.

### CITATION LIST

### Patent Document

Patent Document 1: JP 4981386 B

Patent Document 2: JP 5535740 B

Patent Document 3: JP 5535742 B

### SUMMARY OF INVENTION

### Problems to be Solved by the Invention

As described above, each of the heating medium heating devices disclosed in Patent Documents 1 to 3 has a structure where the heating medium flows by making two U-turns in the heating medium heating device. Such a structure makes the heating medium suffer from a large pressure loss. Hence, for the purpose of securing a sufficient flow rate of the heating medium, the pump that feeds the heating medium to the heating medium heating device has to be made larger in size, for example.

In addition, each of the inlet and the outlet portions formed in a side surface of any one of the first and the second heating medium distribution boxes has to have a certain, large enough diameter to allow a hose member with a predetermined thickness to be coupled to the corresponding one of the inlet and the outlet portions. This makes the above-mentioned one of the first and the second heating medium distribution boxes have a relatively large thickness, which impairs the compactness of the thickness (height) dimension of the heating medium heating device.

The invention, which is made to address such problems, provides a heating medium heating device configured to: reduce the pressure loss of the heating medium in the heating medium heating device; to achieve a higher heat exchange efficiency; and allow the heating medium heating device to have a more compact size. The invention also provides a vehicle air conditioner using such a heating medium heating device.

### Solution to Problem

To solve the above-described problems, the present invention provides the following means.

A heating medium heating device according to a first aspect of the invention includes: a PTC heater; a first heating medium distribution box adhered to a first surface side of the PTC heater and including a first heating medium circulation path formed in the first heating medium distribution box; a second heating medium distribution box adhered to a second surface side of the PTC heater, including a second heating medium circulation path formed in the second heating medium distribution box, and joined to the first heating medium distribution box; an inlet header space that allows upstream ends of the first and the second heating medium circulation paths to communicate with each other, and an outlet header space that allows downstream ends of the first and the second heating medium circulation paths to communicate with each other; an inlet portion that allows a heating medium to flow into the inlet header space; and an outlet portion that allows the heating medium to flow out of the outlet header space.

According to the heating medium heating device with the above-described configuration, the heating medium having flowed from the inlet portion into the inlet header space goes on to split into a flow entering the first heating medium circulation path formed in the first heating medium distribution box and a flow entering the second heating medium circulation path formed in the second heating medium distribution box. While the two flows of the heating medium flow in the same direction, the heating medium is heated through the heat exchange with the PTC heater. Then, the two flows join together in the outlet header space, and the joint flow of the heating medium flows out through the outlet portion into a heater core coupled to the downstream side of the heating medium heating device.

According to this configuration, the heating medium flows, linearly and in the same direction, through the first and the second heating medium circulation paths formed in the heating medium heating device and there is no U-turn flow. Hence, such a configuration reduces the pressure loss of the heating medium.

In the heating medium heating device with the above-described configuration, the inlet header space and the outlet header space may be formed respectively along flow-path width directions of the first and the second heating medium circulation paths, and may extend over entire widths of the flow-path widths of the first and the second heating medium circulation paths.

According to this configuration, the heating medium having flowed from the inlet portion into the inlet header space goes on to flow by spreading quickly to cover the full width of the first heating medium circulation path and the second heating medium circulation path without undergoing any contraction or turning. In addition, once the heating medium finishes flowing through the first heating medium circulation path and the second heating medium circulation path, the heating medium is quickly collected in the outlet header space, and then flows out through the outlet portion. Hence, such a configuration further reduces the pressure loss of the heating medium.

The heating medium heating device with the above-described configuration may further include a protruding portion formed on an inner surface of the inlet header space at a position near the inlet portion and extending in a direction intersecting an inflow direction of the heating medium from the inlet portion.

According to this configuration, part of the heating medium flowing from the inlet portion into the inlet header space hits the protruding portion, and thus that part of the heating medium flows more easily into nearer side areas of the first and the second heating medium circulation paths. Hence, the heating medium is made to flow into the first and the second heating medium circulation paths more evenly over the entire range of the path width of each circulation path, and thus a higher heat exchange efficiency is achieved.

In the heating medium heating device with the above-described configuration, the inlet portion and the outlet portion may be located so that in plan view, axial directions of the inlet and the outlet portions are respectively positioned substantially on the extension lines of axial directions of the inlet and the outlet header spaces, and the protruding portion may be formed on an inner surface of the inlet header space on a side that is away from the first and the second heating medium circulation paths.

According to this configuration, none of the inlet portion and the outlet portion sticks out, in the longitudinal direction of the heating medium heating device, from the corresponding one of the two end portions of the heating medium heating device. The heating medium heating device is thus constructed to be more compact in the longitudinal direction.

In addition, part of the heating medium having flowed from the inlet portion and going on to flow linearly towards the farther side of the inlet header space hits the protruding portion. That part of the heating medium is thus forced to change its flow direction, and is guided to nearer side areas of the first and the second heating medium circulation paths. Hence, the heating medium is made to flow into the first and the second heating medium circulation paths more evenly over the entire range of the path width of each circulation path, and thus a higher heat exchange efficiency is achieved.

In the heating medium heating device with the above-described configuration, any one of the first heating medium distribution box and the second heating medium distribution box may include an electronic component accommodating box member configured to accommodate an electronic component for controlling the PTC heater, and the inlet portion and the outlet portion may be formed in the electronic component accommodating box member.

According to this configuration, the inlet portion and the outlet portion are formed in the electronic component accommodating box member, which has the largest thickness (height) dimension of all of the plurality of box-forming members included in the above-mentioned one of the first and the second heating medium distribution boxes. Hence, even in a case where each of the inlet portion and the outlet portion has a certain, large enough diameter to allow a hose member with a predetermined thickness to be coupled to the corresponding one of the inlet and the outlet portions, such a large enough diameter does not increase the thickness dimension of the above-mentioned one of the first and the second heating medium distribution boxes. Accordingly, the heating medium heating device is thus constructed to be more compact in terms of the thickness (height) dimension.

The heating medium heating device with the above-described configuration includes at least one of an inflow-temperature detecting sensor configured to detect an inflow-temperature of the heating medium flowing in the inlet header space and an outflow-temperature detecting sensor configured to detect an outflow-temperature of the heating medium flowing in the outlet header space.

According to this configuration, the inflow-temperature detecting sensor and the outflow-temperature detecting sensor are respectively disposed in the inlet header space and in the outlet header space, both of which are located near the electronic component accommodating chamber. Hence, while these temperature detecting sensors have higher temperature-detection accuracies, these temperature detecting sensors, together with other electronic components, are accommodated in the electronic component accommodating chamber. Thus, by collecting the electronic components together in a single place, the heating medium heating device is constructed to be a compact device.

In the heating medium heating device with the above-described configuration, at least one of the inflow-temperature detecting sensor and the outflow-temperature detecting sensor may be located near an inclined wall which a flow of the heating medium hits.

According to this configuration, the temperature detecting sensors are disposed in portions to which the temperature of the heating medium is conducted well by being hit by the flow of the heating medium. This allows the detection of the heating-medium temperature to be carried out with a higher accuracy. As each of the portions hit by the flow of the heating medium is inclined, no large resistance is imposed on the flow of the heating medium.

A vehicle air conditioner according to a second aspect of the invention may include:

a blower operable to circulate any of outside air and air in the passenger compartment; a cooler disposed on a downstream side of the blower; and a heater core disposed on a downstream side of the cooler, wherein the heating medium heated by any of the above-described heating medium heating device is allowed to circulate in the heater core, and the vehicle air conditioner achieves the advantageous effects described above.

### Advantageous Effect of Invention

As described thus far, the heating medium heating device according to the invention and the vehicle air conditioner using the heating medium heating device achieve: a reduction of the pressure loss of the heating medium in the heating medium heating device; a higher heat exchange efficiency; and a more compact heating medium heating device.

### BRIEF DESCRIPTION OF DRAWINGS

FIG. 1 is a schematic configuration diagram of a vehicle air conditioner according to an embodiment of the present invention.

FIG. 2 is a perspective view of a heating medium heating device according to an embodiment of the present invention.

FIG. 3 is a front view of a heating medium heating device according to an embodiment of the present invention.

FIG. 4 is a plan view of the heating medium heating device seen from the direction indicated by the arrows IV-IV in FIG. 3.

FIG. 5 is a vertical cross-sectional view of the heating medium heating device taken along the line V-V in FIG. 4.

FIG. 6 is a horizontal cross-sectional view of the heating medium heating device taken along the line VI-VI in FIG. 5.

FIG. 7 is a vertical cross-sectional view of the heating medium heating device taken along the line VII-VII in FIG. 5.

FIG. 8 is a vertical cross-sectional view of the heating medium heating device taken along the line VIII-VIII in FIG. 4 and taken along the line VIII-VIII in FIG. 5.

### DESCRIPTION OF EMBODIMENTS

An embodiment of the present invention will now be described with reference to the drawings.

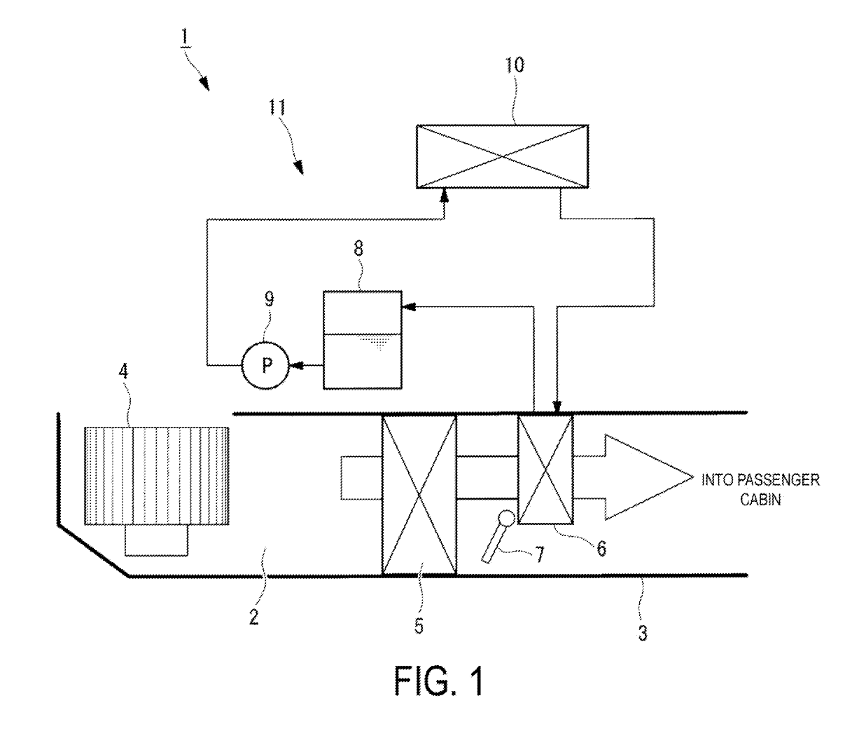

FIG. 1 is a schematic configuration diagram of a vehicle air conditioner according to the present embodiment. A vehicle air conditioner 1 is, for example, an air conditioner of a hybrid vehicle or of an electric-motor vehicle, and includes a casing 3. The casing 3 includes an air flow path 2 configured to take in the outside air or the air in the passenger compartment, adjust the temperature of the taken-in air, and then introduce the temperature-adjusted air into the passenger compartment.

In the casing 3, the following components are installed from the upstream side of the air flow path 2 to the downstream side thereof: a blower 4 configured to suck in the outside air or the air in the passenger compartment and to feed the sucked-in air to the downstream side; a cooler 5 configured to cool the air fed by the blower 4; a heater core 6 configured to heat the air cooled by the cooler 5 while the air is passing through the cooler 5; and an air mixing damper 7 configured to adjust the amount of air passing through the heater core 6 and the amount of air bypassing the heater core 6, and thus adjust the temperature of the mixed air on the downstream side of the air mixing damper 7.

The downstream side of the casing 3 is connected, via an air-outlet mode switching damper and a duct (neither of which is illustrated), to a plurality of air outlet ports (not illustrated) configured to let the temperature-adjusted air out into the passenger compartment. The cooler 5, together with a compressor, a condenser, and an expansion valve (none of which is illustrated) form a refrigerant circuit. The cooler 5 cools the air passing therethrough by evaporating the refrigerant that has been expanded adiabatically by the expansion valve.

The heater core 6, together with a tank 8, a pump 9, and an engine (not illustrated) and the heating medium heating device 10 according to the invention, form a heating medium circulation circuit 11. An engine cooling fluid for hybrid vehicles is used as the heating medium flowing in the heating medium circulation circuit 11. For electric-motor vehicles, equipped with no engines, employ brine for the same purpose. The heating medium circulation circuit 11 is configured to make the heating medium heating device 10 heat the heating medium (i.e., the engine cooling fluid) whose temperature is not raised enough (e.g., while the vehicle is running in the hybrid driving mode), then to make the pump 9 to circulate the heated engine cooling fluid in the heating medium circulation circuit 11, and thus to heat the air passing through the heater core 6 in the casing 3.

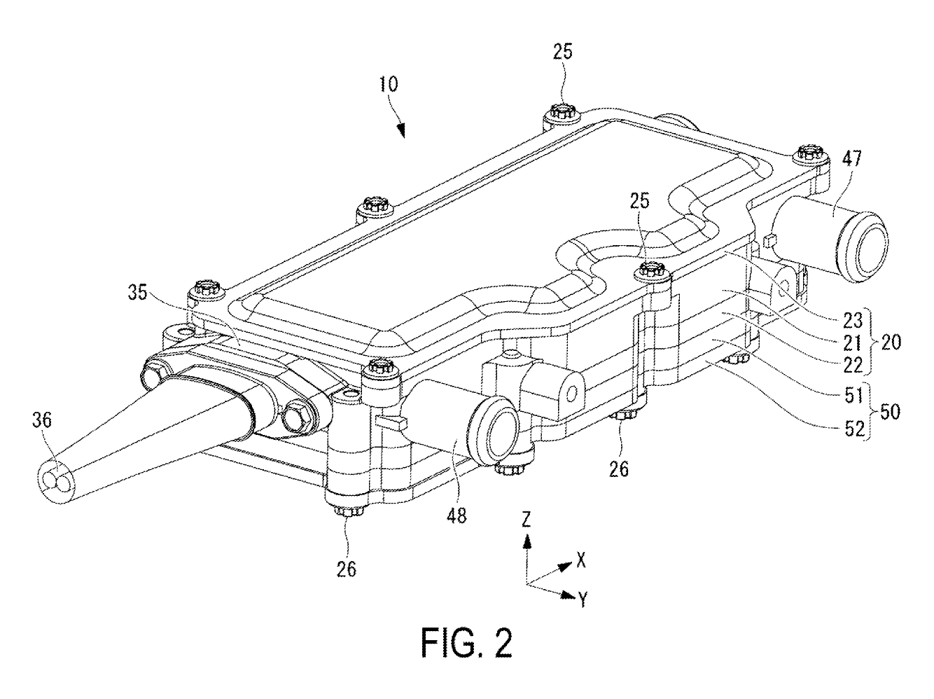

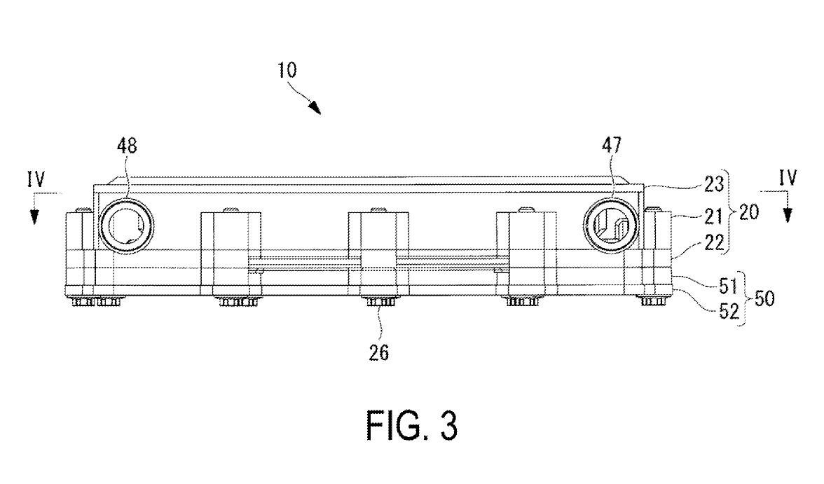

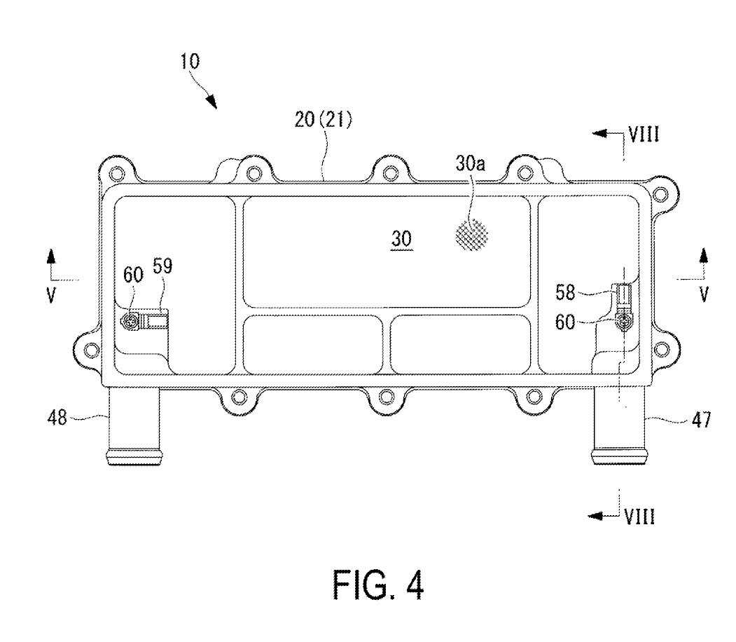

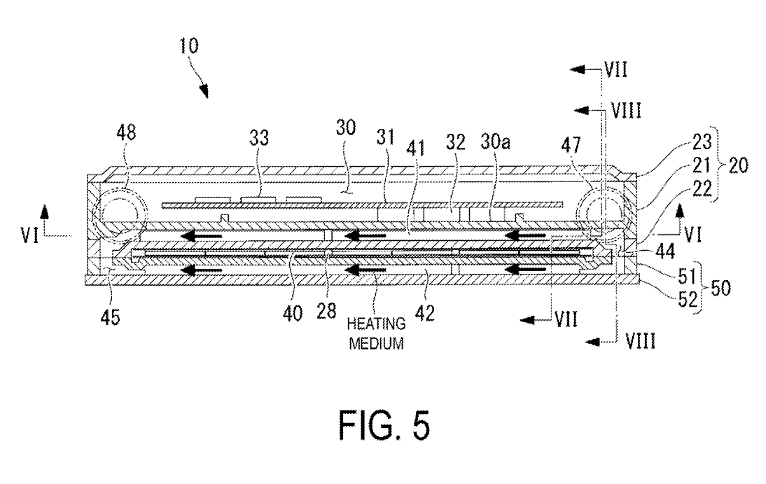

FIG. 2 is a perspective view of a heating medium heating device 10, FIG. 3 is a front view of a heating medium heating device 10, FIG. 4 is a plan view of heating medium heating device 10 seen from the direction indicated by the arrows IV-IV in FIG. 3, and FIG. 5 is a vertical cross-sectional view of the heating medium heating device 10 taken along the line V-V in FIG. 4. Note that in the descriptions given below, the directions X, Y, and Z illustrated in FIG. 2 are defined respectively as the “longitudinal direction”, the “transverse direction”, and the “thickness direction” of the heating medium heating device 10.

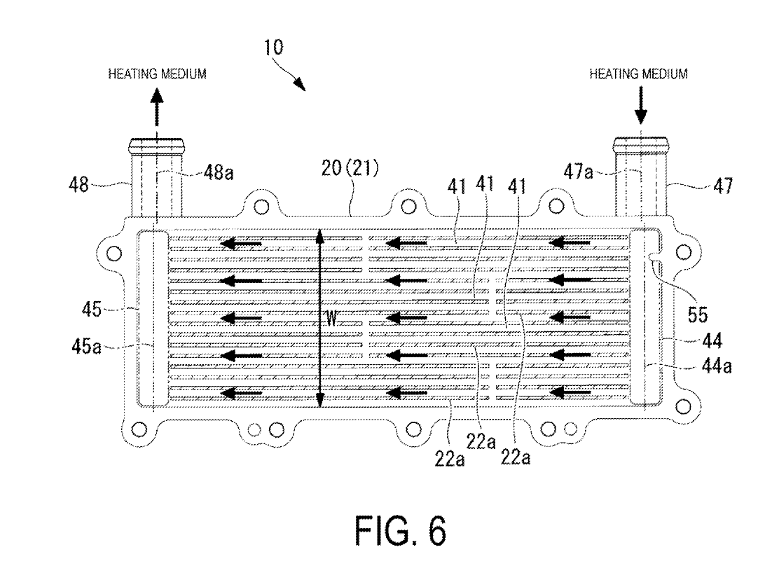

As illustrated in FIG. 2 to FIG. 5 and also in FIG. 6 to FIG. 8, the heating medium heating device 10 includes: a first heating medium distribution box 20 formed in a case shape by stacking, for example, three box-forming members 21, 22, and 23, one upon another; a second heating medium distribution box 50 formed in a case shape by stacking two box-forming members 51 and 52, one upon the other, and joined liquid-tightly to the bottom surface of the first heating medium distribution box 20; and a PTC heater 40 disposed between the first and the second heating medium distribution boxes 20 and 50.

The first heating medium distribution box 20 has a configuration where the upper heating medium distribution box 22 having a rectangular shape in plan view is joined liquid-tightly to the bottom surface of the electronic component accommodating box 21 having a rectangular shape as well, and where an upper cover member 23 is liquid-tightly fitted to cover the upper surface of the electronic component accommodating box 21. In addition, the second heating medium distribution box 50 has a configuration where the lower cover member 52 is liquid-tightly fitted to cover the bottom surface of the lower heating medium distribution box 51, which like the upper heating medium distribution box 22, has a rectangular shape. These box-forming members 21, 22, 23, 51, and 52 are made from a heat conductive material such as an aluminum alloy.

As illustrated in FIG. 2, the upper cover member 23 is fastened to the upper surface of the electronic component accommodating box 21 with a plurality of fixing bolts 25. The upper heating medium distribution box 22, the lower heating medium distribution box 51, and the lower cover member 52 are fastened to the bottom surface of the electronic component accommodating box 21 with a plurality of fixing bolts 26. Hence, the box-forming members 21, 22, 23, 51, and 52 are integrated into a single body. Liquid gasket is applied the interfaces of the box-forming members 21, 22, 23, 51, and 52 to be sealed.

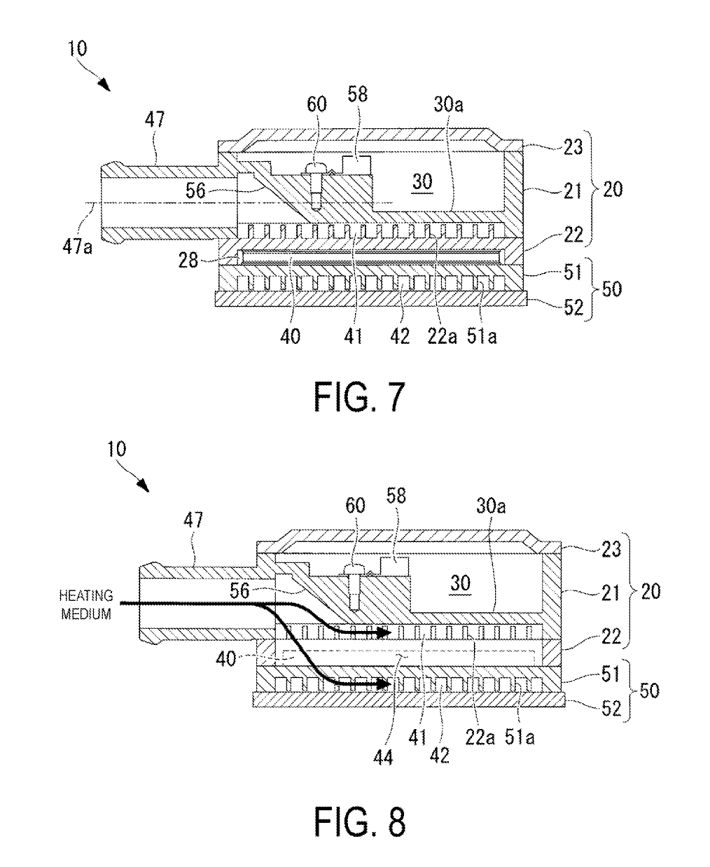

The PTC heater 40 has a flat, rectangular shape that is smaller than the rectangular shape of the upper heating medium distribution box 22 and the rectangular shape of the lower heating medium distribution box 51. As illustrated in FIG. 5 and FIG. 7, a PTC heater accommodating chamber 28 is formed by sealing a tray-shaped, recessed portion formed in the bottom surface of the upper heating medium distribution box 22 with the flat upper surface of the lower heating medium distribution box 51, and the PTC heater 40 is accommodated in the PTC heater accommodating chamber thus formed. The upper surface and the bottom surface of the PTC heater 40 are respectively adhered heat-transmissibly to the bottom surface of the upper heating medium distribution box 22 and the upper surface of the lower heating medium distribution box 51 via a thin heat transmissible sheet, heat transmissible paste, and/or the like.

As illustrated in FIG. 5, FIG. 7, and FIG. 8, the inside of the electronic component accommodating box 21 serves as an electronic component accommodating chamber 30, where a control board (electronic component) 31 configured to control the PTC heater 40 is accommodated. The control board 31 incorporates components such as a heat generating electronic component 32 such as an insulated gate bipolar transistor (IGBT) and a field effect transistor (FET), other electronic components 33, a control circuit, and a power supply circuit.

The bottom surface of the electronic component accommodating box 21 (electronic component accommodating chamber 30) serves as a flat, electronic component cooling wall 30a. As illustrated in FIG. 5, the control board 31 is fixed, with an affixing structure (not illustrated), to a position that is higher than the electronic component cooling wall 30a. In addition, the heat-generating electronic component 32 is disposed on the bottom-surface side of the control board 31 and is in heat-transmissible contact with the electronic component cooling wall 30a. Note that an insulating layer is provided between the electronic component 32 and the wall 30a. As illustrated in FIG. 2, a wire leading-out portion 35 is formed on a first-end surface of the electronic component accommodating box 21, and a wiring member 36 extending from the control board 31 is led out through the wire leading-out portion 35.

As illustrated in FIG. 5, FIG. 7, and FIG. 8, by sealing the tray-shaped recessed portion formed on the bottom surface of the electronic component accommodating box 21 included in the first heating medium distribution box 20 with the flat upper surface of the upper heating medium distribution box 22, a first heating medium circulation path 41 is formed in the first heating medium distribution box 20. A plurality of heat radiation fins 22a are formed in the upper surface of the upper heating medium distribution box 22 along the longitudinal direction of the upper heating medium distribution box 22 (see FIG. 6 to FIG. 8). These heat radiation fins 22a divide the first heating medium circulation path 41 into a plurality of parallel flow paths.

In addition, by sealing the tray-shaped recessed portion formed in the bottom surface of the lower heating medium distribution box 51 included in the second heating medium distribution box 50 with the flat upper surface of the lower cover member 52, a second heating medium circulation path 42 is formed in the second heating medium distribution box 50. A plurality of heat radiation fins 51a are formed on the bottom surface of the lower heating medium distribution box 51 along the longitudinal direction of the lower heating medium distribution box 51 (see FIG. 7 and FIG. 8). These heat radiation fins 51a divide the second heating medium circulation path 42 into a plurality of parallel flow paths.

As described earlier, the flat shaped first heating medium circulation path 41 and the flat-shaped second heating medium circulation path 42 are formed so as to sandwich the similarly flat-shaped PTC heater accommodating chamber 28 and the similarly flat-shaped PTC heater 40. As illustrated in FIG. 5, FIG. 6, and FIG. 8, an inlet header space 44 is formed to secure the communication between the upstream ends of the first heating medium circulation path 41 and the second heating medium circulation path 42 whereas an outlet header space 45 is formed between the downstream ends of the first heating medium circulation path 41 and the second heating medium circulation path 42. As illustrated in FIG. 6 by the long dashed double-short dashed lines, these header spaces 44 and 45 are formed, in plan view, on the two end portions, in the longitudinal direction, of the heating medium heating device 10. Each of the header spaces 44 and 45 extends along the flow-path width direction (the transverse direction) of the first and the second heating medium circulation paths 41 and 42 over the entire range of the flow-path width W of the first and the second heating medium circulation paths 41 and 42.

In addition, an inlet portion 47 and an outlet portion 48 are formed respectively in the inlet header space 44 and the outlet header space 45. The inlet portion 47 and the outlet portion 48 allow the connection with the heating medium circulation circuit 11 (see FIG. 1) where the heating medium circulates. The inlet portion 47 and the outlet portion 48 have union-joint-like shapes allowing the coupling of hose members included in the heating medium circulation circuit 11. As illustrated in FIG. 2, FIG. 7, FIG. 8, and the like, the inlet portion 47 and the outlet portion 48 are formed integrally in the electronic component accommodating box 21, and are formed to overlap the thickness (height) range of the electronic component accommodating chamber 30 formed in the electronic component accommodating box 21 (see FIG. 5, FIG. 7, and FIG. 8).

In addition, as illustrated in FIG. 6, the inlet portion 47 and the outlet portion 48 are located so that in plan view, axial directions 47a and 48a of the inlet portion 47 and the outlet portion 48 are positioned substantially on the extension lines of axial directions 44a and 45a of the inlet header space 44 and the outlet header space 45. To put it another way, in plan view, the inlet portion 47 is linearly connected to the inlet header space 44 whereas the outlet portion 48 is linearly connected to the outlet header space 45.

In addition, a protruding portion 55 extending towards the first and the second heating medium circulation paths 41 and 42 is formed on an inner surface of the inlet header space 44 at a position near the inlet portion 47 and on the side that is away from the first and the second heating medium circulation paths 41 and 42. The height of the protruding portion 55 is set, for example, to approximately 10 to 40% of the inner diameter of the inlet portion 47 or of the path width of the inlet header space 44.

As illustrated in FIG. 8, in side view, the inlet portion 47 is positioned so that the axial direction 47a of the inlet portion 47 passes above the inlet header space 44. A slope portion 56, which is an inclined wall, is formed in the path of the inlet portion 47 at a position on the farther side of the inlet portion 47. The heating medium having flowed in through the inlet portion 47 hits the slope portion 56 and is made to change the flow direction downwards and thus flow into the inlet header space 44.

Though not illustrated, the outlet portion 48 is positioned so that the axial direction of the outlet portion 48 passes above the outlet header space 45, and a slope portion (not illustrated) is formed in the path of the outlet portion 48 at a position on the farther side of the outlet portion 48. The heating medium flows from the outlet header space 45 upwards, hits the slope portion, is made to change the flow direction and thus flow out of the outlet portion 48.

As illustrated in FIG. 4, FIG. 7, and FIG. 8, an inflow-temperature detecting sensor 58 is provided in the inlet header space 44 and an outflow-temperature detecting sensor 59 in the outlet header space 45. These temperature detecting sensors 58 and 59 are fixed to position near the corresponding slope portions 56 with screws 60. The inflow-temperature detecting sensor 58 is a sensor operable to detect the inflow-temperature of the heating medium flowing in the inlet header space 44, whereas the outflow-temperature detecting sensor 59 is a sensor operable to detect the outflow-temperature of the heating medium flowing in the outlet header space 45.

In the heating medium heating device 10 configured as described above, the heating medium flowing in the heating medium circulation circuit 11 illustrated in FIG. 1 flows in through the inlet portion 47 of the heating medium heating device 10 and is introduced into the inlet header space 44 as illustrated in FIG. 6 and FIG. 8. Then, the heating medium splits into the first heating medium circulation path 41 and the second heating medium circulation path 42. Each of the split flows of the heating medium in the first and the second paths 41 and 42 splits into multiple flows to pass through the flow paths formed between the heat radiation fins 22a and 51a of the heating medium circulation paths 41 and 42, respectively. Then, the split flows in these flow paths flow in the same direction (from the right-hand side to the left-hand side in FIG. 5 and FIG. 6).

In the meanwhile, the heating medium is heated though the heat exchange with the PTC heater 40. The heating medium having passed through the first and the second heating medium circulation paths 41 and 42 in the above-described way join together in the outlet header space 45. Then the joint flow of the heating medium flows out through the outlet portion 48 into the heater core 6 coupled to the downstream side of the heating medium heating device 10. The heat of the heated heating medium in the heater core 6 is provided for the purpose of heating the passenger compartment.

On the other hand, the heat-generating electronic component 32 mounted on the control board 31 in the electronic component accommodating chamber 30 of the electronic component accommodating box 21 and positioned to be in contact with electronic component cooling wall 30a exchanges heat via the electronic component cooling wall 30a with the heating medium flowing through the first heating medium circulation path 41, and thus the heat of the heat-generating electronic component 32 is taken away. Hence the heating medium is heated by the PTC heater 40 and by the heat of the electronic components 32 as well.

According to the heating medium heating device 10 with such a configuration, the heating medium flows linearly and in the same direction through the first and the second heating medium circulation paths 41 and 42 formed in the heating medium heating device 10, and thus there is no U-turn flow. Hence, such a configuration reduces the pressure loss of the heating medium.

The inlet header space 44 and the outlet header space 45 extend along the flow-path width direction W of the first and the second heating medium circulation paths 41 and 42, respectively. In addition, each of the spaces 44 and 45 covers the full width of the corresponding flow-path width W. Hence, the heating medium having flowed from the inlet portion 47 into the inlet header space 44 goes on to flow by spreading quickly to cover the full width of the first heating medium circulation path 41 and the second heating medium circulation path 42 without undergoing any contraction or turning. In addition, once the heating medium finishes flowing through the first heating medium circulation path 41 and the second heating medium circulation path 42, the heating medium is quickly collected in the outlet header space 45, and then flows out through the outlet portion 48. Hence, such a configuration further reduces the pressure loss of the heating medium.

The inlet portion 47 and the outlet portion 48 are located so that in plan view (see FIG. 6), axial directions 47a and 48a of the inlet portion 47 and the outlet portion 48 are positioned substantially on the extension lines of axial directions 44a and 45a of the inlet header space 44 and the outlet header space 45. Hence, none of the inlet portion 47 and the outlet portion 48 sticks out, in the longitudinal direction of the heating medium heating device 10, from the corresponding one of the two end portions of the heating medium heating device 10. The heating medium heating device 10 is thus constructed to be more compact in the longitudinal direction.

In addition, the heating medium having flowed in through the inlet portion 47 goes on to flow linearly towards the farther side of the inlet header space 44, but the protruding portion 55 formed on the inner surface of the inlet header space 44 changes the flow direction of some part of the heating medium having flowed in through the inlet portion 47. That part of the heating medium is then introduced to nearer side areas of the first and the second heating medium circulation paths 41 and 42. Hence, the heating medium is made to flow into the first and the second heating medium circulation paths 41 and 42 more evenly over the entire range of the flow-path width W of each of the paths 41 and 42. Accordingly, the heating medium is allowed to efficiently exchange heat with the PTC heater 40, and thus the heating medium heating device 10 achieves a higher heat exchange efficiency.

In addition, in the heating medium heating device 10, as the electronic component accommodating chamber 30 is formed in the electronic component accommodating box 21, the electronic component accommodating box 21 has the largest thickness (height) dimension of all the three box-forming members 21, 22, and 23 included in the first heating medium distribution box 20. In such an electronic component accommodating box 21, the inlet portion 47 and the outlet portion 48 are formed. As illustrated in FIG. 5, FIG. 7, and FIG. 8, the inlet portion 47 (outlet portion 48) overlaps the thickness (height) range of the electronic component accommodating chamber 30.

According to this configuration, the inlet portion 47 and the outlet portion 48 are formed in the electronic component accommodating box 21, which has the largest thickness (height) dimension of all of the plurality of box-forming members 21, 22, 23, 51, and 52 included in the above-mentioned one of the first and the second heating medium distribution boxes 20 and 50. Hence, even in a case where each of the inlet portion 47 and the outlet portion 48 has a certain, large enough diameter to allow a hose member with a predetermined thickness to be coupled to the corresponding one of the inlet and the outlet portions 47 and 48, such a large enough diameter does not increase the thickness dimension of the above-mentioned one of the first and the second heating medium distribution boxes 20 and 50. Accordingly, the heating medium heating device 10 is thus constructed to be more compact in terms of the thickness (height) dimension.

In addition, the heating medium heating device 10 includes: the inflow-temperature detecting sensor 58 operable to detect inflow-temperature of the heating medium flowing in the inlet header space 44; and the outflow-temperature detecting sensor 59 operable to detect the outflow-temperature of the heating medium flowing in the outlet header space 45. To put it another way, the inflow-temperature detecting sensor 58 and the outflow-temperature detecting sensor 59 are respectively disposed in the inlet header space 44 and in the outlet header space 45, both of which are located near the electronic component accommodating chamber 30. Hence, while these temperature detecting sensors 58 and 59 have higher temperature-detection accuracies, these temperature detecting sensors 58 and 59, together with other electronic components, are accommodated in the electronic component accommodating chamber 30. Thus, by collecting the electronic components together in a single place, the heating medium heating device is constructed to be a compact device.

The inflow-temperature detecting sensor 58 and the outflow-temperature detecting sensor 59 are located near the slope portions 56 that the corresponding flows of the heating medium hit. To put it another way, these temperature detecting sensors 58 and 59 are disposed in portions to which the temperature of the heating medium is conducted well by being constantly hit by the flow of the heating medium. This allows the detection of the heating-medium temperature to be carried out with a higher accuracy. As each of the slope portions hit by the flow of the heating medium is inclined, no large resistance is imposed on the flow of the heating medium.

As described thus far, the heating medium heating device 10 according to the present embodiment and the vehicle air conditioner 1 using the heating medium heating device 10 achieve: a reduction of the pressure loss of the heating medium in the heating medium heating device 10; a higher heat exchange efficiency; and a more compact heating medium heating device 10.

Note that the present invention is not limited only to the configuration of the above-described embodiment, and changes and modifications may be made as appropriate. Embodiments having such changes and modifications are included in the scope of claims of the present invention.

For example, the internal structure and/or layout of the heating medium heating device 10 according to the invention may be changed as long as such a change does not allow the heating medium heating device 10 to depart from the scope of the claims.

In addition, the configuration of the vehicle air conditioner 1 according to the invention does not have to be exactly the same as the one illustrated in FIG. 1. The component(s) and/or the layout may be changed appropriately as necessary.

### REFERENCE SIGNS LIST

1 Vehicle air conditioner
4 Blower
5 Cooler
6 Heater core
10 Heating medium heating device
11 Heating medium circulation circuit
20 First heating medium distribution box
21 Electronic component accommodating box
31 Control board (electronic component)
32 Electronic component
33 Electronic component
40 PTC heater
41 First heating medium circulation path
42 Second heating medium circulation path
44 Inlet header space
45 Outlet header space
47 Inlet portion
48 Outlet portion
50 Second heating medium distribution box
55 Protruding portion
56 Slope portion (inclined wall)
58 Inflow-temperature detecting sensor
59 Outflow-temperature detecting sensor
W Flow-path width of heating medium circulation path

1-8. (canceled)

9. A heating medium heating device comprising:
a PTC heater;
a first heating medium distribution box adhered to a first surface side of the PTC heater and including a first heating medium circulation path formed in the first heating medium distribution box;
a second heating medium distribution box adhered to a second surface side of the PTC heater, including a second heating medium circulation path formed in the second heating medium distribution box, and joined to the first heating medium distribution box;
an inlet header space that allows upstream ends of the first and the second heating medium circulation paths to communicate with each other, and an outlet header space that allows downstream ends of the first and the second heating medium circulation paths to communicate with each other;
an inlet portion that allows heating medium to flow into the inlet header space;
an outlet portion that allows the heating medium to flow out of the outlet header space; and
a protruding portion formed on an inner surface of the inlet header space at a position near the inlet portion and extending in a direction intersecting an inflow direction of the heating medium from the inlet portion,
wherein the inlet portion and the outlet portion are located such that in plan view, axial directions of the inlet and the outlet portions are respectively positioned substantially on the extension lines of axial directions of the inlet and the outlet header spaces, and
the protruding portion is formed on an inner surface of the inlet header space on a side that is away from the first and the second heating medium circulation paths.

10. The heating medium heating device according to claim 9, wherein the inlet header space and the outlet header space are formed respectively along flow-path width directions of the first and the second heating medium circulation paths, and extend over entire widths of the flow-path widths of the first and the second heating medium circulation paths.

11. The heating medium heating device according to claim 9, wherein
any one of the first heating medium distribution box and the second heating medium distribution box includes an electronic component accommodating box member configured to accommodate an electronic component for controlling the PTC heater, and
the inlet portion and the outlet portion are formed in the electronic component accommodating box member.

12. The heating medium heating device according to claim 11, further comprising:
at least one of an inflow-temperature detecting sensor operable to detect an inflow-temperature of the heating medium flowing in the inlet header space; and
an outflow-temperature detecting sensor operable to detect an outflow-temperature of the heating medium flowing in the outlet header space.

13. The heating medium heating device according to claim 12, wherein at least one of the inflow-temperature detecting sensor and the outflow-temperature detecting sensor is located near an inclined wall which a flow of the heating medium hits.

14. A vehicle air conditioner comprising:
a blower operable to circulate any of outside air and air in the passenger compartment;
a cooler disposed on a downstream side of the blower; and
a heater core disposed on a downstream side of the cooler,
wherein the heating medium heated by a heating medium heating device according to claim 9 is allowed to circulate in the heater core.
